(19) United States
(12) Patent Application Publication
(10) Pub. No.: US 2011/0048255 A1
(43) Pub. Date: Mar. 3, 2011

(54) PRESS SCREW SEPARATOR

(75) Inventor: Dietrich Eichler, Konigstein (DE)

(73) Assignee: ROHREN- UND PUMPENWERK BAUER GMBH, Voitsberg (AT)

(21) Appl. No.: 12/602,350

(22) PCT Filed: Mar. 10, 2008
(86) PCT No.: PCT/DE08/00423

§ 371 Date: Nov. 30, 2009

(30) Foreign Application Priority Data
May 30, 2007 (DE) 20 2007 007 606.1

(51) Int. Cl. B30B 9/12

(52) U.S. Cl. 100/110

(57) ABSTRACT

The present invention relates to a press screw separator for separating out solid components of a heavy liquid containing solid and liquid components, such as waste water from communal, industrial, or agricultural operations, slurry, etc., comprising: a housing (1), a conveyor screw arrangement (3) rotatably arranged in the housing and having a screw shaft (8) and at least two screw flights (7) arranged on the screw shaft for rotating in unison therewith, a drive for rotating the conveyor screw arrangement, a cylinder-shaped screen basket (18) held in the housing, a ring chamber (S) defined at least between the inner side of the screen basket and the screw shaft, the chamber having a first inner axial section (19) into which the screw flights reach, and a second outer axial section (20) which is free of screw flights, an inlet (25) for the heavy liquid, an outlet (26) for the aqueous components of the heavy liquid, which communicates with the screen basket, and a solid outlet arranged downstream in the direction of conveyance from the ring chamber, characterized in that the ratio of the gap width (s) of the ring chamber (S) with respect to the diameter of the screw shaft (8) is between 3 and 50, preferably 4 and 25, more preferably 5 and 20, most preferably 12, and the gap width (s) of the ring chamber (S) is between 25 mm and 100 mm, preferably 50 mm and 75 mm, most preferably 75 mm.

The invention relates to a press screw separator for separating out solid components of a heavy liquid containing solid and liquid components, such as waste water from communal, industrial, or agricultural operations, slurry, etc. The invention, in particular, relates to a press screw separator having an increased throughput rate.

A press screw separator is known (EP 0 367 037 B1), in which a uni-helical press or conveyer screw is operated in a horizontal position and a ring chamber between the screw shaft and a screen basket is dimensioned in a specific manner. The known press screw separator has a limited throughput rate, however, it is successfully used in many cases, in particular for processing slurry from agricultural farms. Further, an older model of a press screw separator is known (U.S. Pat. No. 3,188,942 A), which comprises an inclined press or conveyor screw having more than one screw flight. In order to enhance the drainage performance, the diameter of the screw shaft is expanded at the end of the screw, for decreasing the gap width of the ring chamber which is, at its outer periphery, confined by a screen basket. This approach has proven to be counterproductive, in that a conical transition area between the original diameter and the expanded diameter may have such an effect on a continuous material throughput, that the throughput rate of the known press screw separator is inferior to that of the press screw separator according to EP 0 367 037 B1, despite the higher constructional effort.

On the other hand, the increasing production of waste water of different origin requires press screw separators having an increased throughput rate, since otherwise a multiplication of known press screw separators having a limited throughput rate would be required—which is not desired also in view of the consumption of primary energy and space. Tests have proven that a merely constructive enlargement of the known press screw separators does not or not sufficiently solve this object.

It is therefore an object underlying the invention to provide a press screw separator of the aforementioned kind, which enables a multiple throughput rate compared to the known press screw separators while having a simple and robust structure and an energy consumption being increased only slightly and unproportionally. Therewith, the press screw separator shall be suited for processing large amounts of waste water, as they e.g. are produced during the manufacturing of paper.

This object is solved according to the invention by the features of claim 1.

With the inventive means, in particular the following advantageous effects in comparison to the known press screw separators are achieved: In the press screw separator mentioned at the beginning, a ratio of the size of the ring gap of a ring chamber between a screen basket and a screw shaft and its diameter is set to a specific low value. Surprisingly, it was found out within the scope of the invention that a substantial increase of the throughput rate depends on the enlargement of the surface of the screen basket at the end of the screw flights. This can be achieved by increasing the mentioned ratio in the manner disclosed in claim 1. Simultaneously, length and diameter dimensions of the screen basket are therewith generated, which enable a high precision production of this sensitive component with a comparably low manufacturing effort and at low costs. The need of primary energy of the inventive press screw separator is considerably lower compared to a plurality of known press screw separators providing an identical throughput rate. According to a further development of the invention, the discharge effect in the ring chamber is promoted in that the solid outlet of the separator is adapted to be closed by a holdup flap arrangement which can be pivoted away by a specific axial force acting in the direction of discharge. This results in a densification of the solid plug and consequently an enhanced dewatering. Another further development of the invention is similarly effective in this sense. According to said development, the longitudinal center axis of the press screw separator can be aligned vertically or inclined with respect to the horizontal, in order to generate a conveyance of material against the gravity effect.

In the following, the invention is explained in detail based on an embodiment and the drawing, in which:

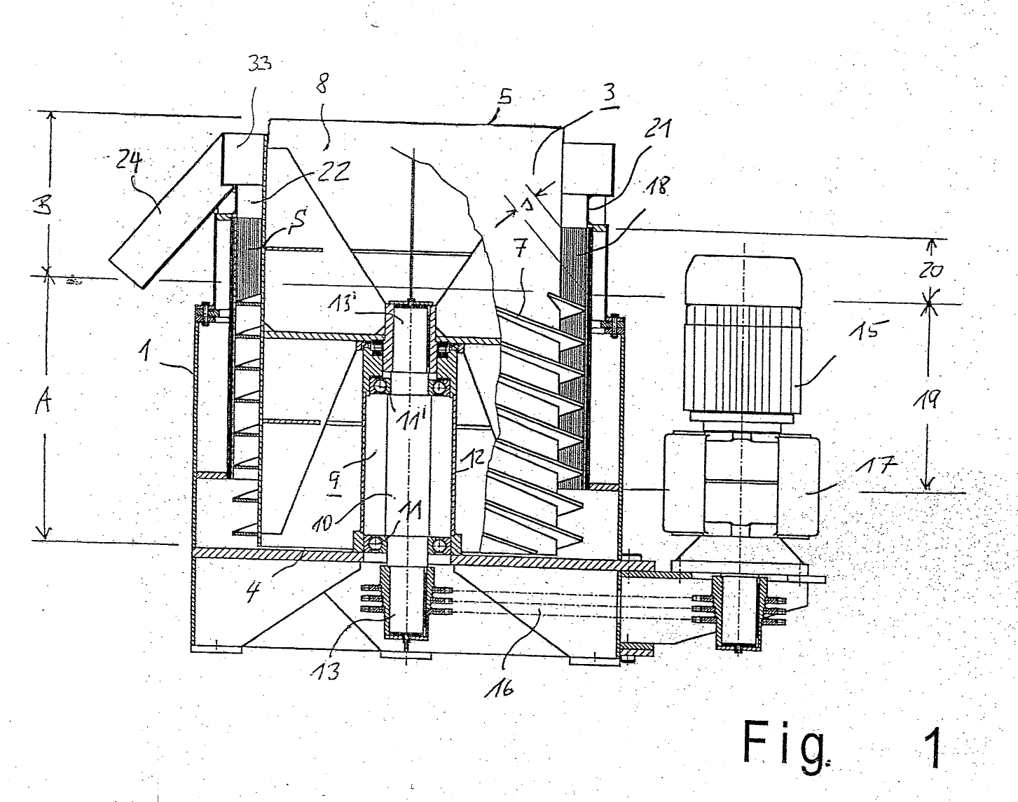

FIG. 1 shows a partially cut view of a press screw separator having a vertically aligned, longitudinal center axis according to an embodiment of the invention;

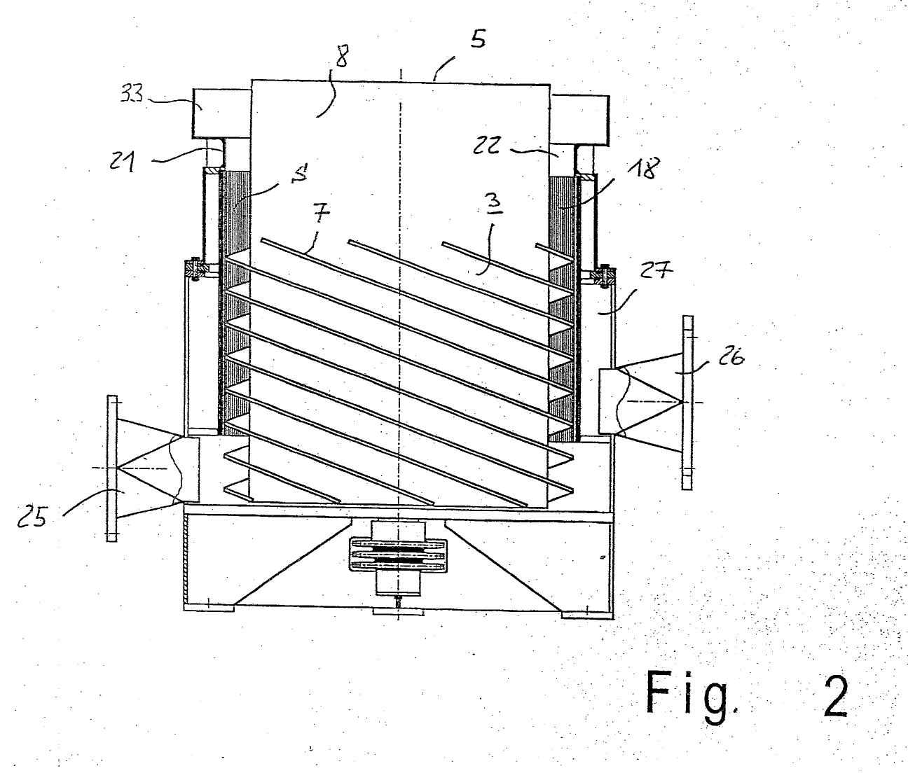

FIG. 2 shows the press screw separator of FIG. 1 in a cut lateral view;

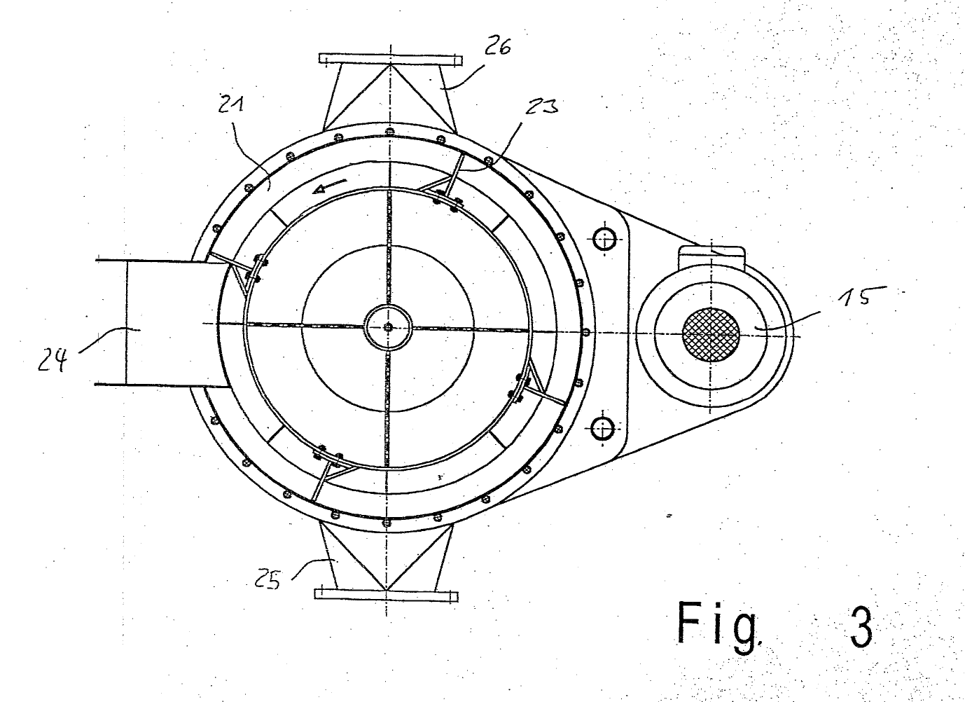

FIG. 3 shows a plan view on the press screw separator of FIG. 1;

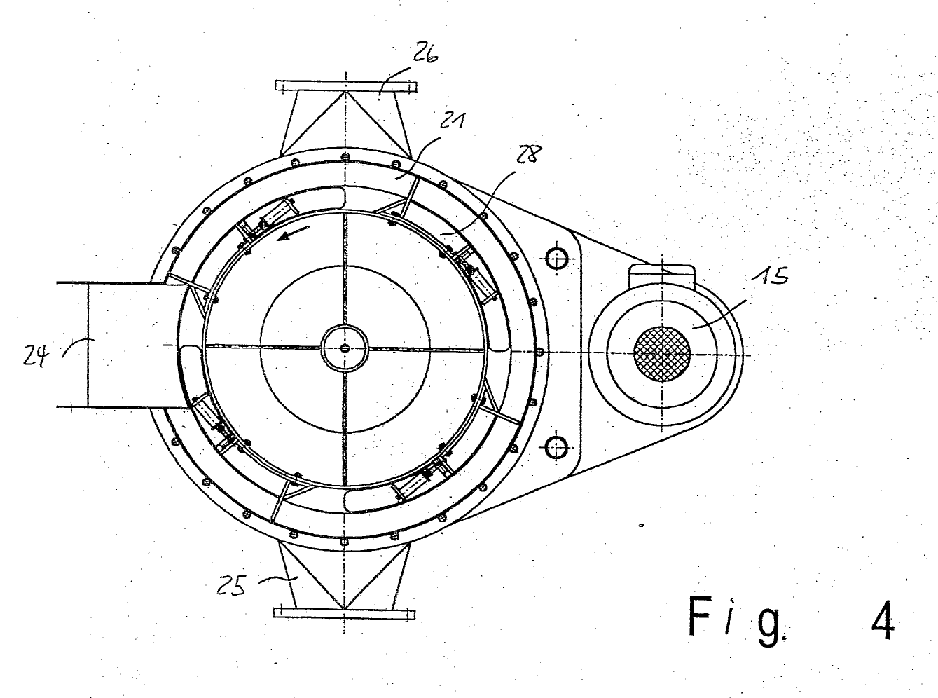

FIG. 4 shows a plan view on a press screw separator having a holdup flap arrangement according to the invention; and

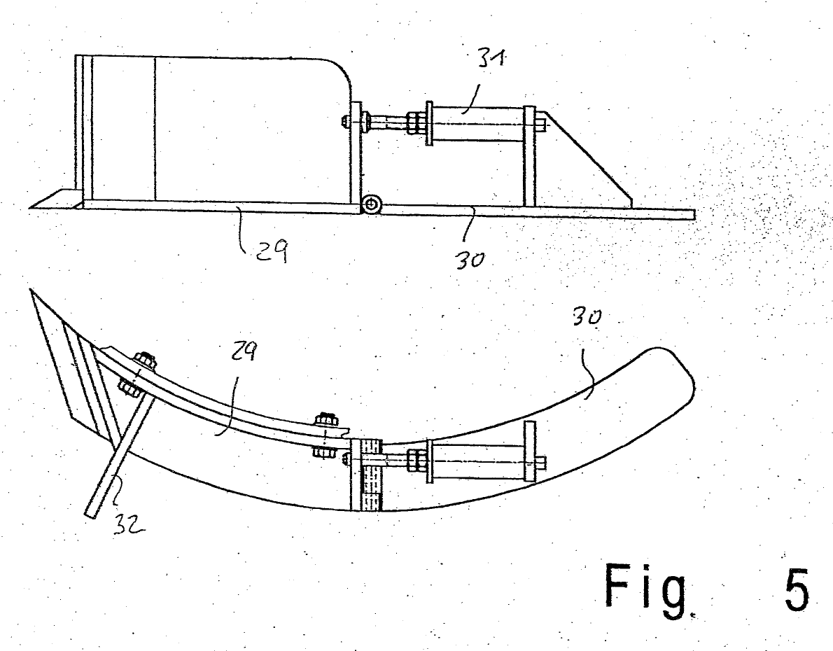

FIG. 5 shows detailed views of the holdup flap arrangement of FIG. 4.

Referring to FIGS. 1 and 2, the basic structure of a press screw separator according to the invention will be described in the following.

Reference numeral 1 designates a housing which defines an inner space in which a conveyer screw arrangement, generally designated with reference numeral 3, is provided, which comprises an inner axial end 4 and an outer axial end 5. In the present embodiment of the invention, the housing 1 is a steel welding construction, however, it could also be a cast steel construction.

The conveyer screw arrangement 3 comprises an initial or inner circumferential portion A, on which two or more screw flights 7 are arranged or mounted for rotating in unison with a screw shaft 8, and an outer portion B near the other axial end 5, which is free of screw flights. The screw shaft 8—as shown—has a radial dimension which is unchanged between the inner and outer axial ends 4, 5. Preferably, the portion A assumes between 60% and 80% of the complete length of the screw shaft 8, whereas the portion B assumes 20% to 40% of the length of the screw shaft.

Reference numeral 9 generally designates a drive shaft and bearing arrangement for the screw shaft 8. The arrangement 9 comprises a drive shaft 10 which is retained rotatably, aligned toward the longitudinal center axis of the screw shaft 8, in a suitable manner, as e.g. indicated at 11, 11′, by a pair of axially spaced axial-radial-roller bearing arrangements in a bearing housing 12. The drive shaft 10 comprises opposite axial shaft stubs 13, 13′, one of which communicates drivingly with the screw shaft 8, whereas the other shaft stub axially protrudes from the screw shaft 8 and communicates drivingly with driving mechanism 15 in the form of an electric motor. Although the drive may be configured in different ways, a belt or chain drive indicated at 16 is preferably provided, which connects a driven shaft of the driving mechanism 15 with the respective shaft stub 13. Reference numeral 17 designates a reduction gear unit for adjusting the speed of the driven shaft appropriately in predetermined steps or continuously. The invention is not limited to the described drive arrangement; others may also be provided, as e.g. described in EP 0 367 037 B1.

In the interior of the housing, a cylindrical screen basket 18 is arranged. The screen basket 18 is preferably structured as described in more detail in EP 0 367 037 B1, such that reference is made to this disclosure. This document is therewith incorporated into the disclosure of the present invention. The screen basket 18 is accordingly formed preferably as a wedge wire filter, the strainer bars of which extend axially parallel, wherein the gap width between the strainer bars preferably ranges between 0.2 mm and 1.5 mm.

The screen basket 18 might be supported “floatingly” along its complete length with respect to the housing 1, as it is described in EP 0 367 037 B1. Preferably, the screen basket 18 of the present embodiment of the invention rests, with its vertically aligned, longitudinal center axis, only on one end portion of the housing 1 facing the outer end 5 of the screw shaft 8, i.e. at a position at which the largest torques occur during operation.

The screen basket 18 is axially penetrated by the conveyor screw arrangement 3, wherein a circular cylindrical ring chamber S is formed between the screw shaft 8 and the inner periphery of the screen basket 18, said chamber having a uniform gap width s which has a specific ratio relative to the diameter of the screw shaft 8.

As shown, the ring chamber S comprises a first or inner section 19 facing the inner axial end 4 of the screw shaft 8 and a second or outer axial section 20 facing the outer axial end 5 of the screw shaft 8. The second axial section 20 of the ring chamber S is free of screw flights 7, whereas the screw flights 7 and their outer edges in the area of the first section 19 are guided near the inner peripheral surface of the screen basket 18.

According to the invention, the ratio of the gap width s relative to the diameter of the screw shaft 8 ranges between 3 and 50, preferably 4 and 25, further preferably 25, and most preferably 12, and the gap width s of the ring chamber S ranges between 25 and 100 mm, preferably 50 and 75 mm, most preferably 75 mm.

The ratio of the gap width s of the ring chamber S relative to the axial distance between adjacent screw flights may be less than 1.0, preferably between 0.5 and 1.0, most preferably 0.75. Each screw flight 7 should be inclined by an angle between 70° and 80° with respect to the longitudinal center axis of the screw shaft 8 in the direction of its conveyance, wherein the distance between adjacent screw flights 7 should range between 80 mm and 120 mm.

At or near the axial end of the housing interior facing the outer axial end 5 of the screw shaft 8, a tubular extension 21 is arranged at the housing 1 in a manner flush with the ring chamber S. An additional ring chamber 22 is defined between the inner peripheral surface of the tubular extension 21 and the outer peripheral surface of the screw shaft 8, which chamber forms an axial continuation of the ring chamber S, however, is not circumferentially confined by the screen basket 18.

The screw shaft 8 axially expands beyond the ring chamber 22 and supports, at its protruding end, one or more, in the present case four, blade-shaped members 23 arranged with an equal angular distance, which protrude radially from the outer periphery of the screw shaft 8 to a suitable extent and rotate in unison with the screw shaft 8. A solid outlet in the form of a chute 24 inclined outwardly from top to bottom is provided at the housing 1, the inlet of which is directed toward the rotating blades 23 such that the blades 23 pass the chute 24 upon rotation of the screw shaft 8. Therewith, solid material entrained by the blades 23 is transported to the chute 24. Preferably, the plug experiences a decompression when exiting the ring chamber 21, in an annular flash chamber 33 arranged downstream of the ring chamber 21, which is provided circumferentially of the screw shaft 8 near its end 5 protruding from the housing 1. Due to the decompression, the solid material decomposes into a crumbling, free flowing material which is supplied to the chute 24 by the blades 23.

Further, an inlet port 25 for the heavy liquid to be treated is provided at the housing 1, to supply said liquid near the inner axial end of the conveyor screw arrangement 3, such that the heavy liquid can be captured by the flights. Further, an outlet port 26 is provided at the housing 1 at a location in alignment with the screen basket 18, for discharging the precipitated liquid exiting at the outer periphery of the screen basket 18 to the outside.

The press screw separator formed as mentioned above functions as follows:

Heavy liquid introduced into the interior of the housing 1 through the inlet port 25 enters the effective range of the conveyor screw arrangement 3 and is transported by the screw flights 7 against the gravity in the direction of conveyance into the first section 19 of the ring chamber S, to perform an initial precipitation of the liquid phase of the heavy liquid. The precipitated liquid phase enters into an outer collecting chamber 27 of the housing 1 and then proceeds to the outlet port 26. The material, which is already partially dewatered, is transported into the second section 20 of the ring chamber S by the conveyor screw arrangement 3, said section being free of screw flights 7. Due to the pushing material which follows, a kind of plug forms in the ring chamber S, from which the remaining aqueous components are squeezed upon a further densification, which components are then discharged through the screen basket 18 to the outside. Consequently, the plug is increasingly dewatered during its movement toward the ring chamber 22 of the tubular extension 21, such that finally, at the outlet of the press screw separator, a plug consisting substantially of solids remains. As soon as the solid plug enters the region of the blades 23, it is deflected by the blades into the chute 24 and can be discharged to the outside for further use, e.g. composting, litter for animal barns or fermentation in biogas production plants.

The described congestion effect by the formation of the plug can be amplified by attaching a holdup flap arrangement 28 at the outlet end of the ring chamber 22 of the tubular extension 21 about the screw shaft 8 for a rotation in unison therewith, as it is shown in FIGS. 4 and 5. The arrangement 28 preferably comprises a plurality of basic bodies 29 having the shape of a segment of a circle and arranged in series circumferentially with equal angular distance, which radially cover the ring chamber 22 at least partially. A flap 30 is hinged at each basic body 29. Each flap 30 can be moved, against a biasing force effected by the solid plug, from a position in which it is aligned substantially flush with the basic body 29 to a position in which the flap 30 more or less uncovers the ring chamber 22 located behind it. The biasing force can be applied by a spring or hydraulic device 31, preferably in an adjustable manner. The holdup flap arrangement 28 has the effect that the solid plug transported against it cannot enter the chute 24 directly, but only if the pressure applied by the plug has reached such an extent that the flaps 30 are pivoted away. This results in an increased densification and thus dewatering of the plug. Reference numeral 32 designates blade-shaped members which have a function similar to that of the blades 23 shown in FIG. 3.

The invention was described above based on an embodiment in which the conveyor screw arrangement is vertically aligned. If desired, the longitudinal center axis of the conveyor screw arrangement may also be inclined to a suitable extent of ±30° with respect to the vertical. Also a horizontal alignment of the conveyor screw arrangement may result in a satisfying precipitation performance in case of specific heavy liquids to be treated. The holdup flap arrangement is not limited to the described embodiment. A holdup flap arrangement as described e.g. in the Korean patent 0289887 could also be provided.

1-10. (canceled)

11. A press screw separator, comprising:
a housing,
a conveyor screw arrangement rotatably arranged in the housing having a screw shaft and at least two screw flights arranged on the screw shaft for rotating in unison therewith,
a drive configured to rotate the conveyor screw arrangement,
a cylinder-shaped screen basket held in the housing,
a ring chamber with a gap width defined at least between an inner side of the screen basket and the screw shaft, the ring chamber having a first inner axial section into which the screw flights reach, and a second outer axial section which is free of the screw flights,
an inlet of the housing configured to receive a mixture of aqueous and solid components,
an outlet in communication with the screen basket configured to receive aqueous components of the mixture, and
a solid outlet arranged downstream in the direction of conveyance from the ring chamber,
wherein the ratio of the gap width of the ring chamber with respect to the diameter of the screw shaft is between about 3 and about 50, and the gap width of the ring chamber is between about 25 mm and about 100 mm.

12. The press screw separator of claim 11, wherein a longitudinal center axis of the conveyor screw arrangement is aligned by an angle of about 90° with respect to a horizontal axis of the conveyor screw arrangement.

13. The press screw separator of claim 11, wherein a longitudinal center axis of the conveyor screw arrangement is aligned by an angle of between about 60° and about 120° with respect to a horizontal axis of the conveyor screw arrangement.

14. The press screw separator of claim 11, wherein the ratio of the gap width of the ring chamber with respect to an axial distance between adjacent screw flights is less than about 1.0.

15. The press screw separator of claim 11, wherein the ratio of the gap width of the ring chamber with respect to an axial distance between adjacent screw flights is preferably between about 0.5 and about 1.0.

16. The press screw separator of claim 11, wherein the ratio of the gap width of the ring chamber with respect to an axial distance between adjacent screw flights is about 0.75.

17. The press screw separator of claim 11, wherein each screw flight is inclined in the direction of conveyance by an angle between about 70° and about 80° with respect to the longitudinal center axis of the screw shaft.

18. The press screw separator of claim 11, wherein the distance between adjacent screw flights is between about 80 mm and about 120 mm.

19. The press screw separator of claim 11, wherein a tubular axial extension into which the screw shaft extends, and the solid outlet, are provided at an outer axial end of the housing.

20. The press screw separator of claim 11, further comprising at least one blade-shaped conveyor member, rotatable in unison with the screw shaft, that is attached at an end portion of the screw shaft proximate the solid outlet, wherein the at least one blade-shaped conveyor member is configured to convey solid matter discharged from the solid outlet away in a substantially tangential direction.

21. The press screw separator of claim 11, wherein a flash chamber surrounding the screw shaft is proximate the solid outlet configured to discharge solid matter.

22. The press screw separator of claim 11, wherein the solid outlet is adapted to be closed by a holdup flap arrangement that is pivotable under a specific axial force acting in the direction of discharge.

23. The press screw separator of claim 22, wherein the holdup flap arrangement comprises a plurality of biased holdup flaps that are arranged circumferentially about a protruding end portion of the screw shaft and configured to rotate in unison with the screw shaft.

24. The press screw separator of claim 23, wherein the biased holdup flaps are configured to rotate in unison with the screw shaft and cover a discharge ring chamber of the solid outlet.

25. The press screw separator of claim 11, wherein the mixture is sewage wastewater.

26. The press screw separator of claim 11, wherein the ratio of the gap width of the ring chamber with respect to the diameter of the screw shaft is between about 4 and about 25.

27. The press screw separator of claim 11, wherein the ratio of the gap width of the ring chamber with respect to the diameter of the screw shaft is about 12.

28. The press screw separator of claim 11, wherein the gap width of the ring chamber is between about 50 mm and about 75 mm.
